(19) United States
(12) Patent Application Publication
(10) Pub. No.: US 2006/0181482 A1
(43) Pub. Date: Aug. 17, 2006

(54) Apparatus for providing visual data during an operation

(76) Inventor: John M. Iaquinto, Dakota Dunes, SD (US)

Correspondence Address: Tony Olson, 801 River Drive, North Sioux City, SD, 57049, US

(21) Appl. No.: 11/050,550

(22) Filed: Feb. 3, 2005

(51) Int. Cl. G09G 5/00

(52) U.S. Cl. 345/8

(57) ABSTRACT

A method and apparatus for providing visual data during an operation is described, comprising a processing base with memory and storage; a source of images such as x-rays and fluoroscopes; and a personally worn display such as a heads-up display. The display provides images of x-rays; fluoroscopic images; ultrasound images; and the like within the field of vision of the person or persons performing detailed medical procedures.

### FIELD OF THE INVENTION

The present invention generally relates to the field of providing information to medical personnel while performing medical procedures.

### BACKGROUND OF THE INVENTION

Medical procedures performed by medical personnel such as doctors and nurses often require the person performing the procedure to be aware of important information such as the patients heart rate, heart rhythm, blood pressure, etc. Furthermore, for some procedures, it is necessary for the person performing the procedure to refer to various chart information, such as X-rays, fluoroscopic images, ultrasound images, Computerized Axial Topography scans (CAT or CT scans), Magnetic Resonance Imaging (MRI images), instructions, reference material and the like. When the procedure is complicated, such as when it is an operation, it is difficult to provide this information within the field of view of the persons performing the procedure. In current practice, often the charts and data are provided using one or more monitors or perhaps back-lit chart displays that often are outside of the field of view of the persons performing the procedure. This causes undo fatigue on the persons performing the procedure, in that each time they refer to the information, they must turn their heads away from the patient and change their focus, then turn back to the patient and refocus on the detailed work they are performing. This constant change in focus and bending of the head may increase fatigue, especially in long operations. Furthermore, valuable time is wasted during the procedure as the focus is changed back and forth.

Prior configurations provide some limited information to medical personnel during a medical procedure. For example, one manufacturer of heads-up displays describes on their web site that the display can be used to show vital signs and endoscopic images. Although useful during a procedure such as an operation, this web site does not cite nor suggest the use of a heads up display for viewing images captured during an operation, perhaps using radiation to show the configuration of bones or blood vessels, especially imaging that is taken during the same time period in which the procedure is being performed. Rather, this citing discusses the use of endoscopic images which are obtained using a light source and sensor and are limited to body cavities.

There are other problems created by having one or more monitors in an operating room. For one, there may be other medical personnel within the area that may interfere with the view of the surgeon who is performing the procedure, requiring the surgeon to reposition themselves or the other medical personnel to step aside when the surgeon needs to consult the information. Another is that the capture equipment, for example the x-ray equipment used during orthopedic surgery called a C-Arm, may impede the ability of the surgeon to see the display. Another problem is the actual space occupied by the monitor or monitors when operating room space is limited.

Therefore, an apparatus to provide imaging information during a medical procedure is needed.

### SUMMARY OF THE INVENTION

Accordingly, the present invention is directed to a method of and apparatus for providing information and data to medical personnel during medical procedures.

In one aspect of the present invention, a heads-up display is worn by at least one of the medical personnel who are performing the procedure, perhaps worn by a surgeon during an operation. In this aspect, the surgeon may move his or her eye slightly to see the information, charts, x-rays, fluoroscopic images, CT scans, instructions or other information that will appear within their field of vision.

In another aspect of the present invention, the medical personnel who are performing the procedure wear glasses onto which an image of the information; charts; x-rays; fluoroscopic images; CT scans; instructions; or other information is displayed. The display may be formed by projecting it onto a glass surface such as the lens of an eyeglass. Alternately, the display may be displayed on an active display such as a liquid crystal display (LCD) integrated into the glass of one or both lenses. In this aspect, the medical personnel may have an unobstructed view of the patient in the center of their field of vision and the information may be displayed around the periphery so as to be visible by moving the eye slightly, perhaps without turning the head.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description serve to explain the principles of the invention.

### BRIEF DESCRIPTION OF THE DRAWINGS

The numerous advantages of the present invention may be better understood by those skilled in the art by reference to the accompanying figures in which:

FIG. 1 is a schematic drawing of a computer system of the present invention.

FIG. 2 is a schematic drawing of a procedure environment and monitor(s) prior to the present invention.

FIG. 3 is a schematic drawing of a procedure environment and wearable display of the present invention.

FIG. 4 is a schematic drawing of a wearable display of the present invention.

FIG. 5 is a schematic drawing of a wearable display of the present invention.

### DETAILED DESCRIPTION OF THE INVENTION

Reference will now be made in detail to the presently preferred embodiments of the invention, examples of which are illustrated in the accompanying drawings.

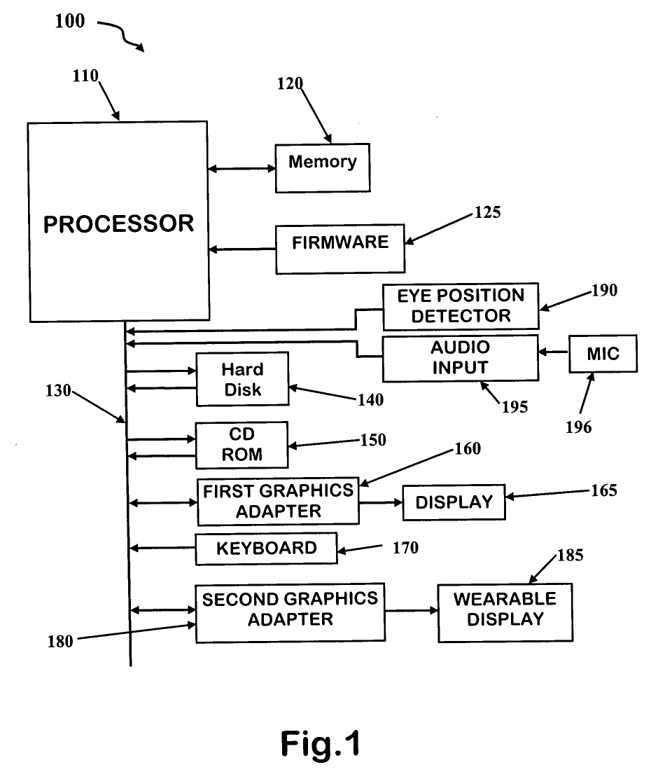

Referring to FIG. 1, a schematic block diagram of a computer-based system of the present invention. In this, a processor 110 is provided to execute stored programs that are generally stored within a memory 120. The processor 110 can be any processor, perhaps an Intel Pentium-4® CPU or the like. The memory 120 is connected to the processor and can be any memory suitable for connection with the selected processor 110, such as SRAM, DRAM, SDRAM, RDRAM, DDR, DDR-2, etc. The firmware 125 is possibly a read-only memory that is connected to the processor 110 and may contain initialization software, sometimes known as BIOS.

This initialization software usually operates when power is applied to the system or when the system is reset. Sometimes, the software is read and executed directly from the firmware 125. Alternately, the initialization software may be copied into the memory 120 and executed from the memory 120 to improve performance.

Also connected to the processor 110 is a system bus 130 for connecting peripheral subsystems such as an image capture apparatus 135, a hard disk 140, a CDROM 150, a first graphics adapter 160, a second graphics adapter 180, an eye position detector 190 and a keyboard 170. The first graphics adapter 160 receives commands and display information from the system bus 130 and generates a display image that is displayed on the display 165. Likewise, the second graphics adapter 180 receives commands and display information from the system bus 130 and generates a display image that is displayed on the wearable display 185.

In general, the hard disk 140 may be used to store programs, executable code and data persistently, while the CDROM 150 may be used to load said programs, executable code and data from removable media onto the hard disk 140. These peripherals are meant to be examples of input/output devices, persistent storage and removable media storage. Other examples of persistent storage include core memory, FRAM, flash memory, etc. Other examples of removable media storage include CDRW, DVD, DVD writeable, compact flash, other removable flash media, floppy disk, ZIP®, laser disk, etc. Other devices may be connected to the system through the system bus 130 or with other input-output functions. Examples of these devices include printers; mice; graphics tablets; joysticks; and communications adapters such as modems and Ethernet adapters. In another embodiment, a single graphics adapter may drive both displays (165 and 185); perhaps with the same display information or perhaps with different display information on each display (165 and 185). In yet another embodiment of the present invention, only one graphics adapter is present and all display information is displayed on the display of the wearable display 185.

The image capture device 135 may be configured to capture images during the procedure. In one embodiment, the image capture device is a fluoroscope, generating fluoroscopic images of internal organs on command during an operation. For example, an orthopedic surgeon may use this device to capture an image of the two sections of a broken bone to guide in the placement of a pin. The fluoroscope uses x-ray radiation or other forms of radiation to capture images of internal organs before or during an operation. An example of a fluoroscope is the GE Medical Systems 9800, often referred to as the “C-Arm,” perhaps because the radiation emitter and capture element are mounted on an arm that resembles the letter ‘C’ so that it may be manipulated around the patient's body. Although FIG. 1 shows an exemplary computing system; the present invention is not limited to any particular computer system architecture.

In some embodiments, there is an eye position detector 190 for monitoring the focus of at least one eye of the person wearing the wearable display. In those embodiments, the eye position detector calculates the general location at which the wearer is looking, allowing the system to blank the wearable display when the wearer is looking straight ahead and enabling the display when the wearer looks toward the location where the display would normally appear.

In some embodiments, there is a voice input system for capturing verbal commands. This voice input system may consist of a microphone 196 connected to an audio input circuit 195 that converts audio signals into digital data that can be processed by the Processor 110 where various algorithms may process the digital audio signals to recognize verbal commands such as “capture image,” “blank display” and “enable display.”

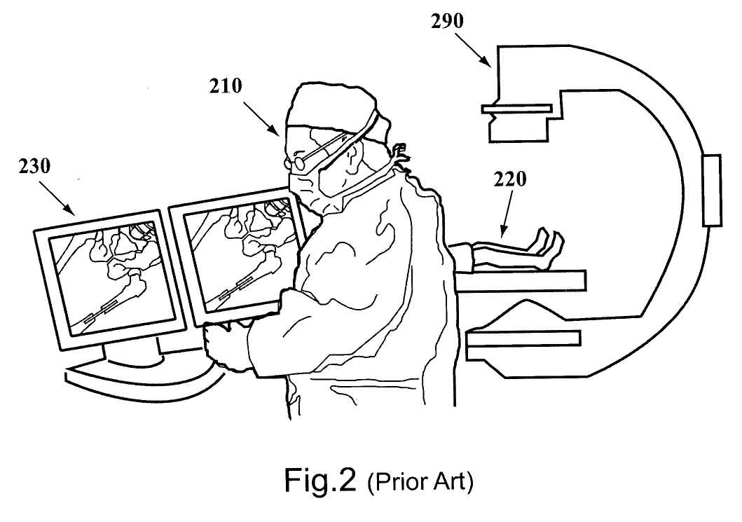

Referring to FIG. 2, a schematic block diagram of a procedure environment and monitor(s) prior to the present invention. Prior to the present invention, the person(s) performing the procedure 210 (e.g., a surgeon) on a patient 220 would have to turn their head away from the focus of the procedure to view information such as x-rays, fluoroscopic images, CT scans, procedure instructions, remote instructions, etc. presented on the monitor(s) 230. The procedure may be an orthopedic, neurosurgical, urologic or vascular operation in which case the procedure environment may be an operating room. Furthermore, especially in cramped operating rooms, the surgeon may have to look around other people or equipment to see the monitor(s) 230. The procedure may be, for example, a complicated operation requiring many hours of detailed work. In this, the surgeon 210 may become tired and fatigued during a long procedure. Many procedures or operations require many hours of detailed steps. Adding to the fatigue is the constant turning of the surgeon's head to view the monitor 230, focusing on the monitor 230, and then turning back to the patient 220 and refocusing on the patient 220. The images shown on the monitor may be fluoroscopic images captured from a fluoroscope 290, often in the configuration of the letter “C” allowing images to be captured of the patient 220 at various angles.

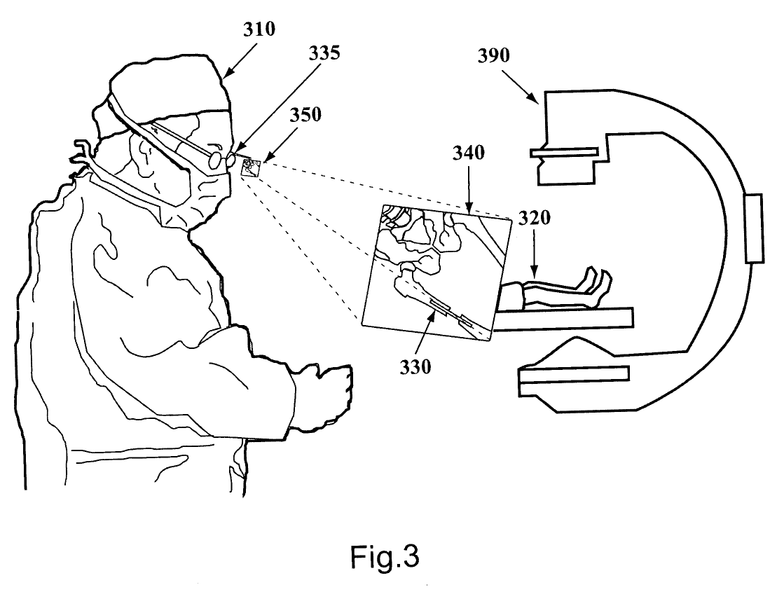

Referring to FIG. 3, a schematic block diagram of a procedure environment and wearable display of the present invention. In the present invention, the person(s) performing the procedure 310 (e.g., a surgeon operating on a patient 320) would have access to important information provided by a wearable display 335. A wearable display is one that moves with the person wearing it and is visible without requiring a great deal of movement. Heads-up displays are an example of wearable displays and generally consist of a display element such as an LCD 350 affixed to an apparatus that is worn on the person's head, perhaps mounted to an eyeglass frame. The image or information 340 appears on the display 350. The procedure may be an orthopedic, neurosurgical, urologic or vascular operation in which case the procedure environment may be an operating room. By displaying important information such as x-rays, fluoroscopic images, CT scans, MRI images, procedure instructions, remote instructions, etc. within the field of view of the person(s) performing the procedure 310, fatigue may be reduced since they would not be required to turn their head to access the information. The information would be visible by a slight movement of their eye. In this example, a fluoroscopic image 340 of the patient 320 is captured during the operation by fluoroscope 390 and is displayed on the heads-up display 350. The exploded view 340 shows what the surgeon 310 might see on the display 350, perhaps a broken bone with pin inserted 330.

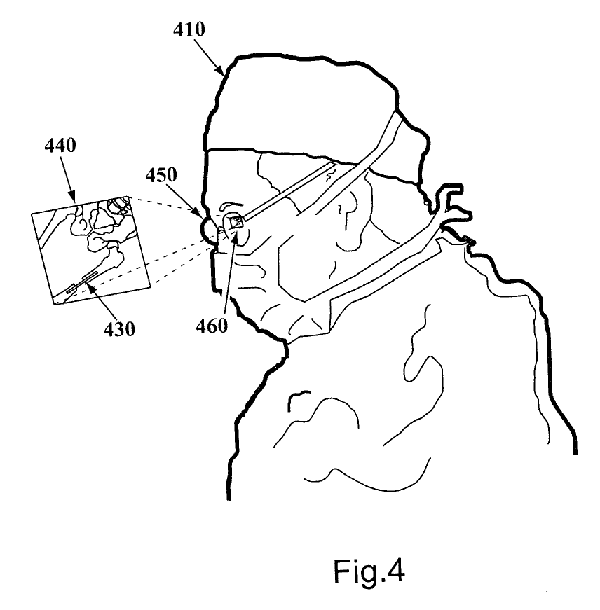

Referring to FIG. 4, a schematic block diagram of a procedure environment of the present invention. In the present invention, the person(s) performing the procedure 410 (e.g., a surgeon) would have access to important information provided by a wearable display 460 located on one or both lenses of a pair of glasses 450. The procedure may be, for example, a complicated operation requiring many hours of detailed work. By displaying important information such as x-rays, fluoroscopic images, CT scans, procedure instructions, remote instructions, etc. within the field of view of the person(s) performing the procedure, fatigue may be reduced since they would not be required to turn their head to access the information. The information would be visible by a slight movement of their eye. In this example, a fluoroscopic image 440 is displayed within a rectangular area 460 of glasses 450. In this embodiment, part of all or one or both lenses of the glasses 450 worn by the surgeon 410 would contain an integrated display, perhaps an LCD that when off, would appear as clear glass and when enabled, display an image, in this example, an image of a fractured bone with a repair pin 430. In another embodiment of the present invention, a sensor or eye position detector 190 is integrated into the wearable display and configured to detect where the wearer is looking. Using information from the eye position detector 190, the system can blank the display when the wearer is looking substantially straight ahead, e.g., looking at the patient, and enable the display when the wearer is looking substantially where they would expect the display to appear, possibly reducing distractions caused by continuously displaying information within the wearer's field of vision.

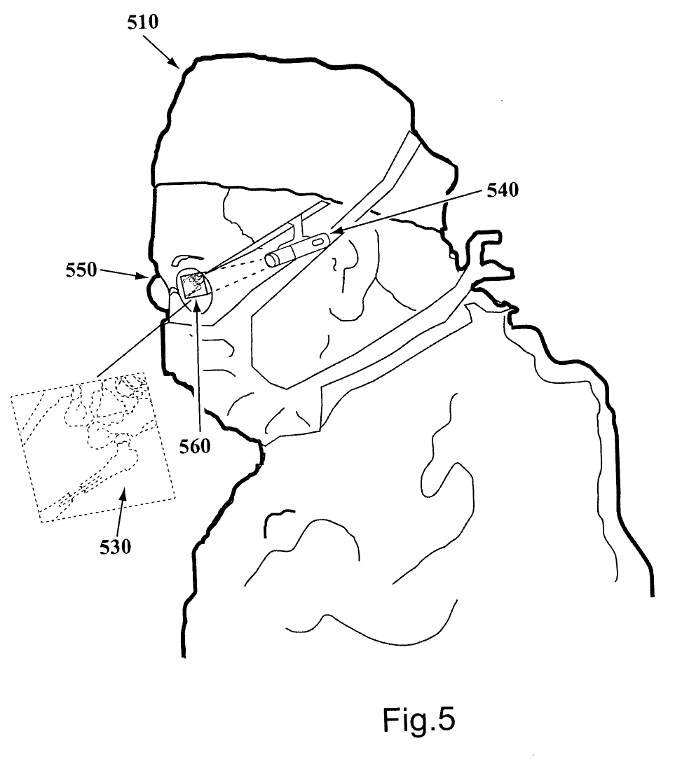

Referring to FIG. 5, a schematic block diagram of a procedure environment of the present invention. In the present invention, the person(s) performing the procedure 510 (e.g., a surgeon) would have access to important information provided by a wearable display 560 located on one or both lenses of a pair of glasses 550. By displaying important information such as x-rays, fluoroscopic images, CT scans, procedure instructions, remote instructions, etc. within the field of view of the person(s) performing the procedure, fatigue may be reduced since they would not be required to turn their head to access the information. The information would be visible by a slight movement of their eye. In this example, a fluoroscopic image 530 is projected by a projector 540 onto an area 560 of a lens of glasses 550 worn by surgeon 510. In another embodiment of the present invention, a sensor or eye position detector 190 is integrated into the wearable display and configured to detect where the wearer is looking. Using information from the eye position detector 190, the system can blank the display when the wearer is looking substantially straight ahead, e.g., looking at the patient, and enable the display when the wearer is looking substantially where they would expect the display to appear, possibly reducing distractions caused by continuously displaying information within the wearer's field of vision.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. An apparatus for presenting information during a medical procedure comprising:
a processor;
an image capture device operatively coupled to said processor and configured to capture at least one image of internal organs;
a graphics adapter operatively coupled to said processor for generating a display image from said at least one image of internal organs;
a wearable display operatively coupled to said graphics adapter configured to display at a minimum said display image within the field of view of an operating personnel.

2. The apparatus of claim 1, whereas said medical procedure is chosen from a group consisting of an orthopedic operation, a neurosurgical operation, a urologic operation and a vascular operation.

3. The apparatus of claim 2, whereas said image capture device uses radiation to capture said images of internal organs.

4. The apparatus of claim 2, whereas said image capture device is a fluoroscope and said at least one image is a fluoroscopic image.

5. The apparatus of claim 1, whereas said wearable display is a heads-up display affixed to an eyeglass frame.

6. The apparatus of claim 1, further comprising a detector configured to detect the position of at least one eye of a person wearing said wearable display, said detector coupled to said processor and said processor enabling said display when said person is looking in the direction of said display and displaying said display when said person is looking in a direction other than the direction of said display.

7. An apparatus for presenting information during a medical procedure comprising:
a processor;
a fluoroscope operatively coupled to said processor and configured to capture at least one fluoroscopic image of internal organs;
a graphics adapter operatively coupled to said processor for generating a display image from said at least one fluoroscopic image of internal organs;
a wearable display operatively coupled to said graphics adapter configured to display at a minimum said display image within the field of view of an operating personnel.

8. The apparatus of claim 7, whereas said medical procedure is chosen from a group consisting of an orthopedic operation, a neurosurgical operation, a urologic operation and a vascular operation.

9. The apparatus of claim 7, whereas said wearable display is a heads-up display affixed to an eyeglass frame.

10. The apparatus of claim 7, whereas said wearable display comprises a pair of eyeglasses including at least one lens, an eyeglass frame and a projector mounted upon said eyeglass frame, whereas said projector is configured to project said display image onto at least one of said at least one lens.

11. The apparatus of claim 10, whereas said wearable display further comprises an eye position detector operatively coupled to said processor configured to determine the approximate location at which a wearer of said wearable display is looking.

12. The apparatus of claim 11, whereas said processor is configured to use information from said eye position detector to blank said projector when said wearer of said wearable display is looking away from the approximate location where said projector is configured to project said display image onto at least one of said at least one lens.

13. A means for presenting information during a medical procedure comprising:
a means for capturing fluoroscopic medical images; and
a means for displaying said medical images within a display area, said means for displaying being affixed to a frame that is worn on the head of a medical personnel.

14. The means for presenting information during a medical procedure of claim 13, whereas said medical images is chosen from a group consisting of images of bones, images of joints, images of nerves, images of ducts and images of blood vessels.

15. The means for presenting information during a medical procedure of claim 13, whereas said means for displaying medical images is a heads-up display.

16. The means for presenting information during a medical procedure of claim 13, whereas said means for displaying medical images is a projector configured to project said medical images onto a lens of a pair of glasses.

17. The means for presenting information during a medical procedure of claim 15, further comprising a means to detect the location at which said medical personnel is looking.

18. The means for presenting information during a medical procedure of claim 17, wherein said means to detect is coupled to said means for displaying and when said means to detect indicates said medical personnel is looking towards said display area, enabling said means for displaying and when said means to detect indicates said medical personnel is looking away from said display area, disabling said means for displaying.

19. The means for presenting information during a medical procedure of claim 15, further comprising a means to receive verbal commands.

20. The means for presenting information during a medical procedure of claim 19, wherein said means to receive verbal commands provides recognition of commands for controlling the operation of the heads-up display.
